(19) United States
(12) Patent Application Publication
(10) Pub. No.: US 2026/0166759 A1
(43) Pub. Date: Jun. 18, 2026

(54) JOINT WITH TWO DEGREES OF FREEDOM

(71) Applicant: POLLEN ROBOTICS, BORDEAUX (FR)

(72) Inventors: Matthieu LAPEYRE, BORDEAUX (FR); Jérémy LAVILLE, ST JEAN LE VIEUX (FR); Steve NGUYEN, BORDEAUX (FR)

(73) Assignee: POLLEN ROBOTICS, BORDEAUX (FR)

(21) Appl. No.: 19/123,544

(22) PCT Filed: Oct. 25, 2023
(86) PCT No.: PCT/FR2023/051671

§ 371 Date: Apr. 23, 2025

(30) Foreign Application Priority Data
Oct. 28, 2022 (FR) 2211299

(51) Int. Cl. B25J 17/02; B25J 9/10; B25J 13/08

(52) U.S. Cl. CPC B25J 17/0258; B25J 9/102; B25J 13/088

(57) ABSTRACT

A parallel joint (1) with two degrees of freedom for a robot comprising a base (2) and a head (3) fixed freely in rotation on the base (2), the head (3) additionally comprising an active surface (3a) fixed freely in rotation in the head (3), the head (3) comprising three bevel gears (6a, 6b, 6c), a first bevel gear (6a) being borne by a first axis (7a), a second bevel gear (6b) being borne by a second axis (7b), a third bevel gear (6c) being secured to the active surface (3a) and being disposed so as to mesh simultaneously with the first bevel gear (6a) and the second gear (6b), the second axis (7b) passing through the first bevel gear (6a) and the first hollow axis (7a), the first axis (7a) and the second axis (7b) being coaxial and mechanically connected to a first motor and a second motor, respectively.

### TECHNICAL FIELD

The technical field of the invention is robotic limb joints, and more particularly such joints with two degrees of freedom.

### PRIOR ART

Robotic limbs generally use several joints in order to have the best possible mobility, just like the limbs of a human being or an animal.

A joint involves at least one degree of freedom, generally two or three degrees of freedom. By degrees of freedom, it is meant the possibility of performing rotation about a predefined axis. Thus, with two degrees of freedom, a joint allows rotation about two distinct predefined axes, which are generally orthogonal. With three degrees of freedom, a joint allows rotation about three distinct predefined axes, which are generally orthogonal as well.

Depending on its location in the robotic limb, the joint requires a minimum number of degrees of freedom to enable it to operate. It might seem simpler to employ only joints with three degrees of freedom for each of the joints of a limb. Nevertheless, such joints with three degrees of freedom are heavier, more expensive and more complex to control than their counterparts with two degrees of freedom. It is therefore advantageous to have joints with two degrees of freedom complementarily to joints with three degrees of freedom.

Such joints with two degrees of freedom are known from the state of the art. The following documents illustrate different variations of these joints.

Document Bsili R. et al. ‘An evolutionary approach for the optimal design of iCub mk. 3 Parallel Wrist’ IEEE-RAS 18th International Conference on Humanoid Robots (Humanoids 2018), Aug. 11, 2018, Beijing, China describes a mechanism for a robotic wrist, with two degrees of freedom as well as design parameters therefor for maximising angles achievable for each degree of freedom.

Document Penčić M. et al. ‘Social Humanoid Robot SARA: Development of the Wrist Mechanism’, IOP Conference Series Materials Science and Engineering. 294(1): 012079-1-012079-10 describes another robotic wrist mechanism with two degrees of freedom, allowing flexion/extension of 115° and lateral deviation of 45°.

Document Jager, J et al. (2017) ‘Joint level modelling, characterisation and torque control of the SHERPA robotic arm’, MSs report, Robotics and Mechatronics, University of Twente describes a joint included in a robotic arm disposed on a rover. The arm comprises seven degrees of freedom distributed between a shoulder, an elbow and a wrist. The shoulder and elbow are in the form of joints with two degrees of freedom, while the wrist has three degrees of freedom.

Document Olaru I. et al ‘Novel Mechanical Design of Biped Robot SHERPA Using 2 DOF Cable Differential Modular Joints’ IROS: Intelligent Robots and Systems, Oct 2009, St. Louis, MO, USA. pp. 4463-4468, (10.1109/IROS.2009.5354425) describes a joint with two degrees of freedom, the feature of which is that it relies on the combination of cables and pulleys.

It is apparent from these different documents that joints with two degrees of freedom according to the state of the art are of a large overall size and expensive.

The purpose of the present application is to overcome these technical problems.

### DISCLOSURE OF THE INVENTION

One object of the invention is a parallel joint with two degrees of freedom for a robot comprising a base and a head fixed freely in rotation on the base, the head also comprising an active surface fixed freely in rotation in the head so that the axis of rotation of the active surface is between a plane normal to the axis of rotation of the head relative to the base, the head comprising three bevel gears, a first bevel gear being borne by a first axis, a second bevel gear being borne by a second axis, a third bevel gear being secured to the active surface and being disposed so as to mesh simultaneously with the first bevel gear and the second gear, the first axis and the second axis being coaxial with each other and with the axis of rotation of the head relative to the base, the first axis being hollow, the second axis passing through the first bevel gear and the first axis, the first axis and the second axis being mechanically connected to a first motor and a second motor, respectively.

The joint may comprise a sensor for measuring rotation of the head relative to the base and a sensor for measuring rotation of the active surface relative to the head.

The second axis can be hollow, with the communication cable of the sensor for measuring rotation of the active surface relative to the head thereby passing through the first axis and the second axis.

The head may comprise a passive surface fixed freely in rotation relative to the head, and comprising a port in its centre such that a cable can pass through the port, the first hollow axis and the second hollow axis to emerge in the base.

The first axis and the second axis can be mechanically connected to a first motor and a second motor respectively, by means of a gear transmission, one motor being connected to a first gear meshing with a second gear connected to the corresponding axis.

The first axis and the second axis can be mechanically connected to a first motor and a second motor respectively, by means of a pulley and belt transmission, one pulley being connected to a motor, the other pulley being connected to the corresponding axis, the two pulleys being connected via the belt.

A belt transmission can be connected to the active surface, a first pulley being connected to the active surface and to a holding element, a second pulley being fixed integrally with the active surface and being fixed freely in rotation on the holding element, so that its position relative to the active surface is held, the two pulleys being connected via a belt.

Another object of the invention is a method for controlling a joint with two degrees of freedom as described above, wherein the two motors are controlled so that they rotate in different directions and at the same speed to rotate the head relative to the base, and the two motors are controlled so that they rotate in the same direction and at the same speed to rotate the active surface relative to the head.

Another object of the invention is a robotic limb comprising at least two segments connected together via a joint with two degrees of freedom as described above.

### BRIEF DESCRIPTION OF THE DRAWINGS

Other aims, characteristics and advantages of the invention will appear upon reading the following description, given solely as a non-limiting example and made with reference to the appended drawings wherein:

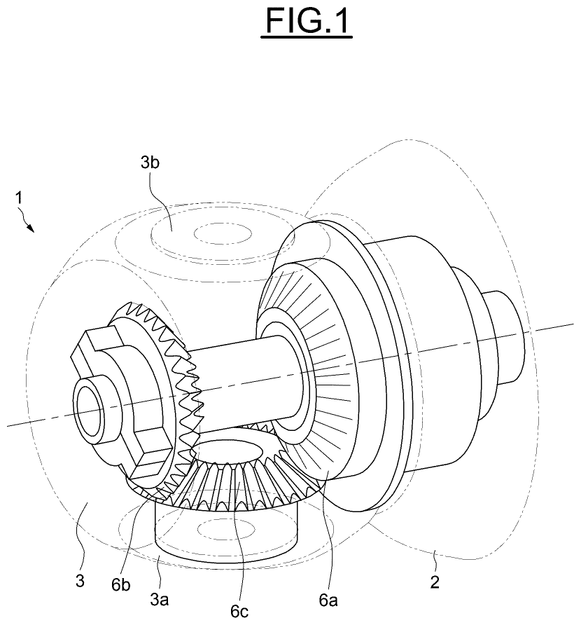

the figure FIG. 1 illustrates the main elements of the joint with two degrees of freedom according to the invention,

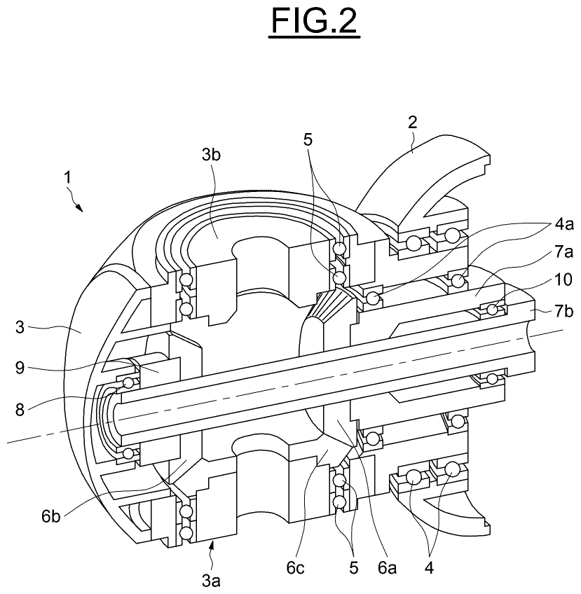

the figure FIG. 2 illustrates a cross-section view of the joint with two degrees of freedom according to the invention,

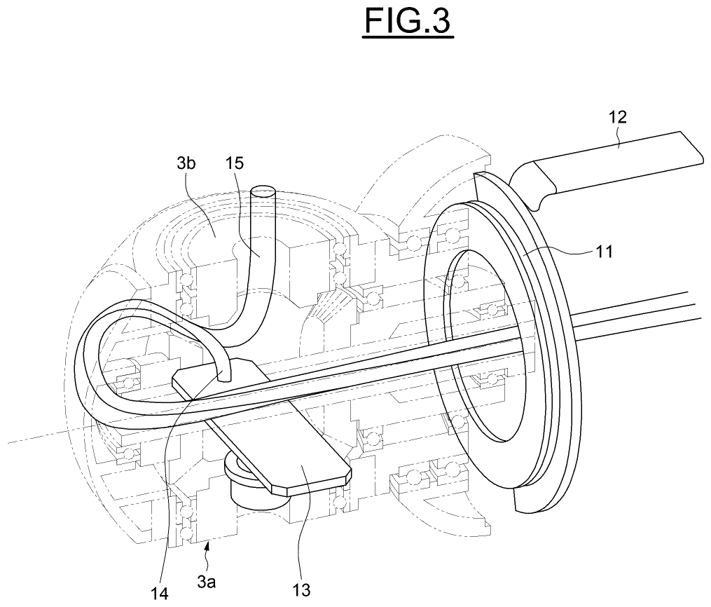

the figure FIG. 3 illustrates a cross-section view of the joint with two degrees of freedom according to the invention showing the arrangement of the rotation sensors,

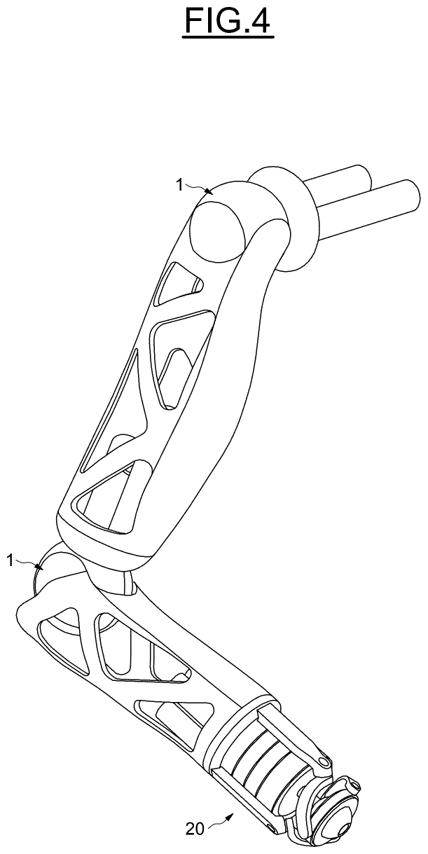

the figure FIG. 4 illustrates a robotic arm comprising the joint with two degrees of freedom according to the invention,

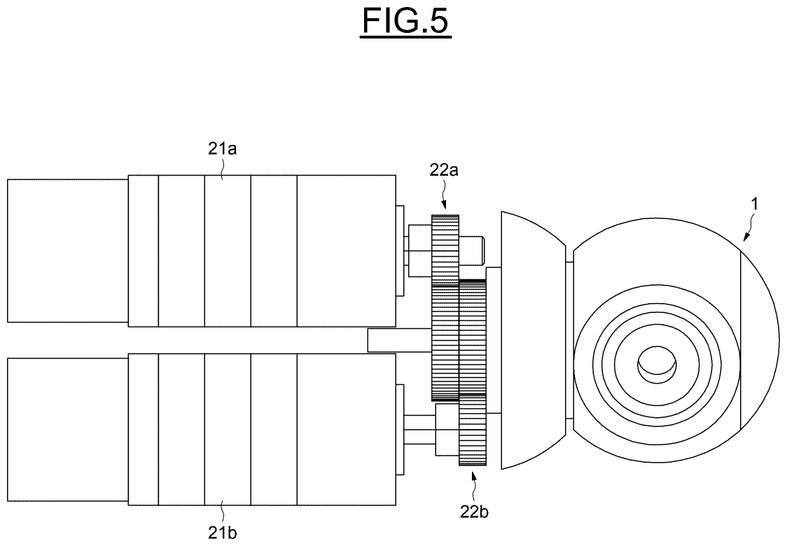

the figure FIG. 5 illustrates a first embodiment as regards the motor drive of the joint 1 with two degrees of freedom,

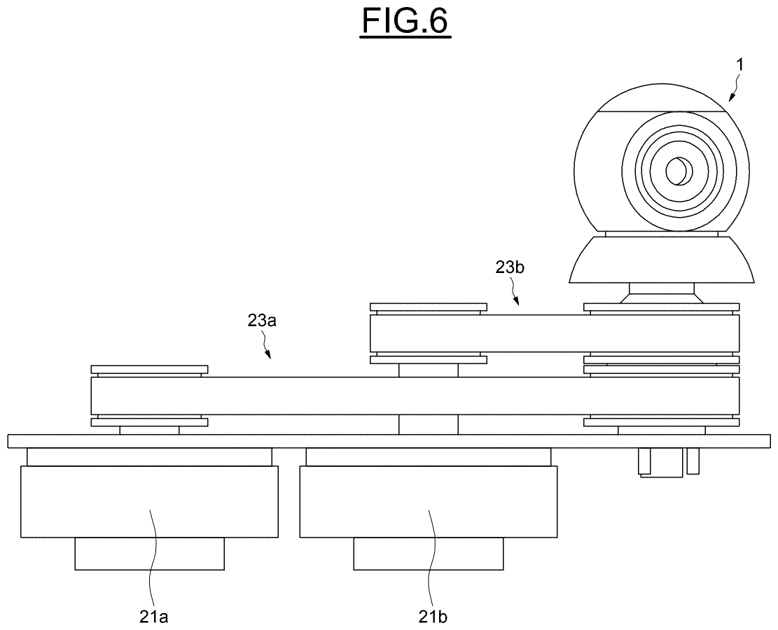

the figure FIG. 6 illustrates a first embodiment as regards the motor drive of the joint 1 with two degrees of freedom, and

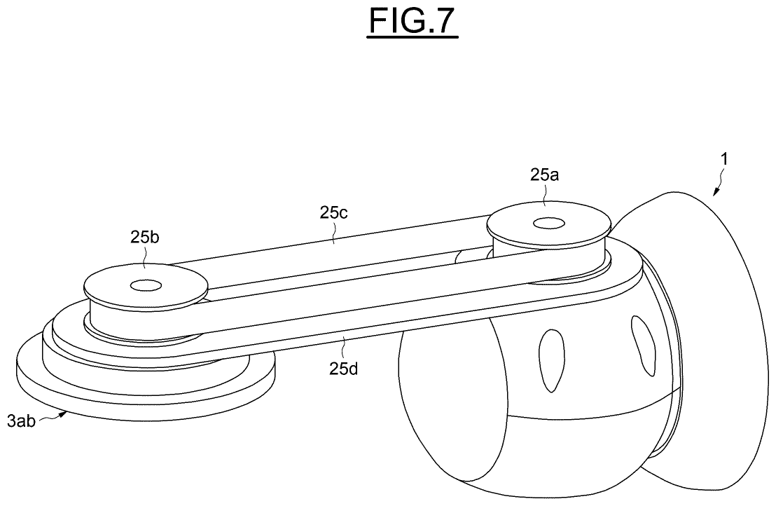

the figure FIG. 7 illustrates an embodiment of offset of the mechanical output of the joint 1 with two degrees of freedom.

### DETAILED DESCRIPTION

In order to solve the technical problem and have a joint with two degrees of freedom, the applicant has noticed that the use of two nested motor axes surprisingly made it possible to have a joint with two degrees of freedom whose motors are arranged on a same side, thus improving compactness of the joint as well as mass distribution in a robotic limb.

The joint 1 with two degrees of freedom according to the invention is illustrated in figure FIG. 1. The joint 1 comprises a base 2 and a head 3 fixed freely in rotation on the base 2.

The head 3 comprises a spherical part joined with a cylindrical part. The cylindrical part of the head 3 is inserted into a corresponding opening of the base 2.

The head 3 additionally comprises an active surface 3a and a passive surface 3b directly opposite to each other, fixed freely in rotation in the head 3, such that the axis of rotation of the active surface 3a and the passive surface 3b passes through the centre of the spherical part of the head 3 and is contained in a plane normal to the axis of the cylindrical part of the head 3.

The movement of the head 3 and the movement of the active surface 3a rely on three bevel gears 6a, 6b, 6c disposed in the head 3. The first bevel gear 6a and the second bevel gear 6b are disposed one in front of the other.

The third bevel gear 6c is mechanically secured to the active surface 3a such that a rotation imparted to the third bevel gear 6c is also transmitted to the active surface 3a. The third bevel gear 6c meshes simultaneously with the first bevel gear 6a and the second bevel gear 6b.

The joint thus formed comprises a first degree of freedom in rotation about the connection between the base 2 and the head 3 along the axis of revolution of the cylindrical part of the head 3, and a second degree of freedom in rotation about the connection between the head 3 and the active surface 3a along the axis of revolution of the active surface 3a.

A rotation with the first degree of freedom is achieved when the first bevel gear 6a and the second bevel gear 6b rotate in opposite directions.

A rotation with the second degree of freedom is achieved when the first bevel gear 6a and the second bevel gear 6b rotate in the same direction. The third bevel gear 6c is thereby subjected to a speed of rotation equal to the speed of rotation of the first bevel gear 6a or the second bevel gear 6b.

The figure FIG. 2 illustrates a cross-section view of the joint 1 with two degrees of freedom according to the invention.

In addition to the main elements described above, figure FIG. 2 illustrates the inner structure of the base 2, the head 3 and the active surface 3a.

The active surface 3a has a disc shape and is mechanically connected to the third bevel gear 6c. However, it remains free in rotation relative to the head 3.

Similarly, the passive surface 3b has a disc shape and is left free in rotation relative to the head 3.

A set of bearings 5 contributes to holding the active surface 3a and the passive surface 3b in the head 3 while allowing rotation.

Another set 4 of bearings enables the cylindrical part of the head 3 to be held in place relative to the base 2, while allowing rotation relative to the axis of the cylindrical part of the head 3. Similarly, a different set 4a of bearings enables the cylindrical part of the head 3 to be held in place relative to the first axis 7a, while allowing rotation relative to the axis of the cylindrical part of the head 3.

The first bevel gear 6a is connected to a first axis 7a connected to a first motor. The second bevel gear 6b is connected to a second axis 7b connected to a second motor.

The first axis 7a and the second axis 7b are therefore coaxial to allow for this arrangement. This is especially achieved by making at least the first axis 7a in the form of a hollow axis, the second axis 7b being disposed inside the first axis 7a. The second axis 7b passes through the first bevel gear 6a and the second bevel gear 6b up to a support bearing 8. A flange 9 is disposed between the second bevel gear 6b and the support bearing 8 in order to make a rigid coupling between the second bevel gear 6b and the second axis 7b. The first bevel gear 6a is in turn held in position by a shoulder provided in the first axis 7a and against which the first bevel gear 6a is in contact. Another bearing 10 enables the second axis 7b to be held in the first axis 7a while allowing rotation.

The concentric axis design and the through arrangement of the second axis 7b relative to the first bevel gear 6a and the second bevel gear 6b allows the two motors to be disposed on the same side of the joint. This configuration is very advantageous for use within a robotic arm since the two motors can then be located on the side of the frame supporting the base 2. It will be understood that, by design, the two axes are held coaxial relative to each other by the different bearings. In addition, their diameters are selected so that there is no friction between the tubes.

The two-degree-of-freedom joint 1 thus designed makes it possible to have two axes of freedom, on each of which an infinite rotation can be performed.

The figure FIG. 3 illustrates the sensors disposed in a joint 1 with two degrees of freedom according to the invention.

A first rotation sensor 11 is disposed in the base 2 at the interface between the base 2 and the cylindrical part of the head 3. The first rotation sensor 11 comprises a fixed part connected to the base 2 and a movable part connected to the cylindrical part of the head 3. The fixed part is especially a magnetic sensor configured to measure variations in the magnetic field. The movable part is especially a magnetic ring equipped with at least one encoder. The magnetic sensor detects a variation in the magnetic field when the magnetic ring is rotated upon rotating the head 3.

The set of magnetic sensors and magnetic element is designed in terms of size, distance, intensity and sensitivity such that the magnetic sensors can detect the magnetic element and the position of the magnetic element can be determined as a function of the intensity measured by each sensor. The first rotation sensor 11 is equipped with a connection cable 12.

A second rotation sensor 13 is disposed in the active surface 3a of the head, so as to measure the position thereof relative to a rest position or relative to a magnetic element secured to the rest of the head 3.

When the joint 1 with two degrees of rotation is equipped with these sensors, it is thus possible to determine the absolute or relative position of each part of the joint 1 so that close-loop control of each degree of freedom is possible.

In one particular embodiment, the second axis 7b is hollow like the first axis 7a, thus providing a favoured path for the circulation of different cables. This path is especially employed for passing a connection cable of the second rotation sensor 13.

This path can also be employed for circulating a cable 15 connecting equipment or actuators disposed downstream of the joint 1. The cable 15 then emerges through a port provided in the centre of the passive face 3b. Such a cable 15 especially makes it possible to supply power to and control the equipment or actuators disposed downstream. This is particularly important when the joint 1 with two degrees of freedom is employed as the shoulder or elbow in a robotic arm as illustrated in figure FIG. 4, wherein at least one actuator 20, herein a wrist joint, is disposed downstream of the joints 1 with two degrees of freedom. The joint 1 with two degrees of freedom disposed in the elbow is also located downstream of the joint with two degrees of freedom disposed in the shoulder and benefits from the circulation of its power supply and control cable inside the hollow axes of this shoulder joint. Generally, a robotic limb can thus comprise a joint 1 with two degrees of freedom disposed between two segments of the limb.

The importance of the bearings 5 between the head 3 and the passive face 3b will also be understood. Indeed, when integrated into a robotic limb such as that illustrated in figure FIG. 4, the limb segment following a joint 1 with two degrees of freedom is fixed to the active surface 3a. This limb segment is also fixed to the passive surface 3b in order to share supporting forces and prevent them from being supported by the active surface 3a alone. As soon as the limb segment is fixed to the passive surface 3b, the latter needs to be provided with freedom of rotation so as to follow the rotational movement imparted by the active surface 3a to the limb segment. The presence of bearings 5 makes this possible.

The upstream and downstream interfacing of the joint will now be addressed.

The figure FIG. 5 illustrates a first embodiment as regards the motor drive of the joint 1 with two degrees of freedom.

A first motor 21a is mechanically connected to the first axis 7a by means of a first set of gears 22a for performing a reduction.

Similarly, the second motor 21b is mechanically connected to the second axis 7b by means of a second set of gears 22b, for making a reduction.

The two motors 21a, 21b are thus disposed as an extension of the joint 1, which is advantageous in the case of a joint between two limbs, such as the elbow or the knee. The overall size of the system is reduced because the motors are integrated into the forelimb.

In one particular embodiment, the first motor 21a and the second motor 21b have the same characteristics, with the two sets of gears 22a, 22b thus having a same reduction ratio.

In a second embodiment of the motor drive of the joint 1 with two degrees of freedom, illustrated in figure FIG. 6, the first axis 7a is connected to the first motor 21a by a first set of pulleys and belt 23a. Similarly, the second axis 7b is connected to the second motor 21b via a second set of pulleys and belt 23b.

Such an arrangement makes it possible to offset the motors 21a, 21b and to modify the centre of mass or the overall size of the robot in the vicinity of the joint 1. This is especially advantageous in the case of a joint 1 employed for a shoulder or a hip, insofar as the motors 21a, 21b can then be disposed in the chassis (i.e. the torso) of the robot.

The figure FIG. 7 illustrates a rotation offset output from the joint. In one such embodiment, the output of the joint, corresponding to the active surface 3a included in the joint head 3, is connected to a first pulley 25a. A second pulley 25b is disposed at the place of rotation offset. A belt 25c is disposed so as to transmit rotation from the first pulley 25a to the second pulley 25b.

The belt 25c can only play its role of transmission between the two pulleys 25a, 25b if a minimum tension is applied thereto. In addition, the belt 25c is limited in the torsion it can accept, so that the two pulleys 25a, 25b have to remain substantially in the same plane. In order to satisfy these restrictions, a holding element 25d is mechanically secured to bearings allowing rotation of axes of the pulleys 25a, 25b. A holding element 25d allows pulleys 25a, 25b to be held in appropriate relative positions for driving via the belt 25c. Such a holding element 25d is also secured to the head 3 of the joint in such a way as to hold relative positions of the second pulley 25b and the head 3 of the joint while allowing rotation of the active surface 3a connected to the pulley 25a.

As with the embodiment illustrated in figure FIG. 6, this embodiment has the advantage of offsetting the centre of mass of the system. This is advantageous for joints between forelimbs and hind limbs such as the knee or elbow. Indeed, the centre of mass of the joint is then located closer to the joint between the forelimb and the torso, reducing stresses on the same. Motor drives can then be used more efficiently for the same force output or scaled down to gain in mass and cost.

1. A parallel joint (1) with two degrees of freedom for a robot comprising two motors (5a, 5b), a base (2) and a head (3) fixed freely in rotation on the base (2), the head (3) also comprising an active surface (3a) fixed freely in rotation in the head (3) so that the axis of rotation of the active surface (3a) is between a plane normal to the axis of rotation of the head (3) relative to the base (2), the head (3) comprising three bevel gears (6a, 6b, 6c), a first bevel gear (6a) being borne by a first axis (7a), a second bevel gear (6b) being borne by a second axis (7b), a third bevel gear (6c) being secured to the active surface (3a) and being disposed so as to mesh simultaneously with the first bevel gear (6a) and the second gear (6b), the first axis (7a) and the second axis (7b) being coaxial with each other and with the axis of rotation of the head (3) relative to the base (2), the first axis (7a) being hollow, the second axis (7b) passing through the first bevel gear (6a) and the first axis (7a), the first axis (7a) and the second axis (7b) being mechanically connected to the first motor (5a) and the second motor (5b), respectively.

2. The joint according to claim 1, comprising a sensor for measuring rotation of the head (3) relative to the base (2) and a sensor for measuring rotation of the active surface (3a) relative to the head (3).

3. The joint according to claim 2, wherein the second axis (7b) is hollow, the communication cable of the sensor for measuring rotation of the active surface relative to the head thereby passing through the first axis (7a) and the second axis (7b).

4. The joint according to claim 3, wherein the head (3) comprises a passive surface (3b) fixed freely in rotation relative to the head (3), and comprising a port in its centre so that a cable can pass through the port, the first hollow axis (7a) and the second hollow axis (7b) to emerge in the base (2).

5. The joint according to any of claims 1 to 4, wherein the first axis (7a) and the second axis (7b) are mechanically connected to the first motor (5a) and the second motor (5b) respectively, by means of a gear transmission, one of said motors being connected to a first gear meshing with a second gear connected to the corresponding axis.

6. The joint according to any of claims 1 to 4, wherein the first axis (7a) and the second axis (7b) are mechanically connected to the first motor (5a) and the second motor (5b) respectively, by means of a belt and pulley transmission, one pulley being connected to one of said motors, the other pulley being connected to the corresponding axis, the two pulleys being connected via the belt.

7. The joint according to any of claims 1 to 6, wherein a belt transmission is connected to the active surface (3a), a first pulley (25a) being connected to the active surface (3a) and fixed freely in rotation on a holding element (25d), a second pulley (25b) being fixed integrally with an offset active surface (3ab) and being fixed freely in rotation on the holding element (25d), so that its position relative to the active surface (3a) is held, the two pulleys being connected via a belt (25c).

8. A method for controlling a joint (1) with two degrees of freedom according to any of claims 1 to 7, wherein the two motors are controlled so that they drive the axes (7a, 7b) such that they rotate in different directions and at the same speed to rotate the head (3) relative to the base (2) and the two motors are controlled so that they drive the axes (7a, 7b) such that they rotate in the same direction and at the same speed to rotate the active surface (3a) relative to the head (3).

9. A robotic limb comprising at least two segments connected together via a joint (1) with two degrees of freedom according to any of claims 1 to 7.
